(19) United States
(12) Patent Application Publication
(10) Pub. No.: US 2016/0230786 A1
(43) Pub. Date: Aug. 11, 2016

(54) HYDRAULIC PRESSURE GENERATION UNIT WITH PNEUMATIC ACTUATION

(71) Applicant: Ércio Miguel NEMA, São José dos Campos (BR)

(72) Inventor: Ércio Miguel NEMA, São José dos Campos (BR)

(21) Appl. No.: 15/023,076

(22) PCT Filed: Sep. 18, 2014
(86) PCT No.: PCT/IB2014/064640

§ 371 Date: Mar. 18, 2016

(30) Foreign Application Priority Data
Sep. 23, 2013 (BR) BR1020130243078

(51) Int. Cl. F15B 11/072; F15B 1/26; F15B 13/02; F15B 3/00

(52) U.S. Cl. CPC F15B 11/0725; F15B 3/00; F15B 1/265; F15B 13/021; F15B 13/027; F15B 2211/30

(57) ABSTRACT

A “HYDRAULIC PRESSURE GENERATION UNIT WITH PNEUMATIC ACTUATION” in particular a multifunction unit activated by low pressure air, consisting of at least one pump (1), preferably two pumps (1 and 2), which are pneumatically automated, comprising a pneumatic cylinder (5) with a medial plunger (7), in addition to two symmetrical and opposite hydraulic plungers (8 and 9) limiting an upper hydraulic chamber (1 A and 2 A) and another lower hydraulic chamber (1 B and 2 B) having different volumes, wherein since they work in parallel and out-of-phase a reduced oil volume is required and the pulsating movement thereof is removed.

### FIELD OF APPLICATION

The present invention refers to a compact and multifunction hydraulic pressure generation unit with pneumatic actuation applicable to a wide majority of equipment and machines using this type of power, whose feature is the use of low-pressure compressed air to drive said unit capable of actuating as hydraulic pump, as well as pressure booster and accumulator, providing great electric power economy and solving several limits of conventional hydraulic units.

### Conventional Hydraulic Unit

Conventional hydraulic units have specific functions and they may be equipped with boosters and accumulators of hydraulic pressure.

### I) Hydropneumatic Pumps

In conventional hydropneumatic pumps, compressed air from a compressor passes through a pressure regulating valve and through a five-way pneumatic directional valve being routed to a rear pneumatic chamber pushing a pneumatic plunger, which in turn moves the shaft of a hydraulic piston resulting in the compression of the oil stored in the chamber placed in its opposite side. By pressurizing the oil forces the one-way check valve to open, allowing its arrival to a hydraulic directional valve and thence to a hydraulic cylinder or similar machine element. Depending on the position of said hydraulic cylinder, the directional valve actuates to move it forward or backward. Thus, the piston shaft continues its motion, pushing the oil from the chamber to a point where the pneumatic plunger contacts and drives a directional (pneumatic) valve, which sends an air flow to the five-way pneumatic directional valve, which changes position and starts sending the pressurized air to the front air chamber, forcing the hydraulic plunger to move up, followed by the hydraulic piston. At this time, the one-way check valve allowing the oil to flow is blocked automatically by the action of a spring, while another one-way check valve is released allowing the passage of the oil contained in the reservoir to fill the pressure chamber. At the end of the climb, the pneumatic plunger makes contact with the upper pneumatic directional control valve that sends air flow to the five-way pneumatic directional valve, which changes position and starts sending the compressed air to the rear air chamber again, restarting the entire cycle.

### Hydropneumatic Pumps Limitations

a) Pulsating movement:

Delivering small oil volume to the hydraulic cylinder or to a similar machine element which will move in proportion to said volume. Thus, the cylinder displacement is directly proportional to the oil volume. Hence, if the sent oil volume allows the cylinder to move only 1 mm, each new displacement produces a delay corresponding to the return time of the pneumatic plunger in order to fill the hydraulic pressurization chamber. Within this context, the movement produced by the hydropneumatic pump is not considered continuous but rather pulsating, not meeting any equipment where the continuous and uniform movement is paramount.

b) Waiting time for filling the hydraulic pressurization chamber:

When the pump is sucking the oil from the reservoir inside the pressurizing chamber, the hydraulic cylinder remains at rest, that is, the forward movement is stopped due to the lack of oil. The hydraulic cylinder moves again only when the pressurizing chamber is completely full and starts the compression movement of the hydraulic piston shaft.

c) Low volume of oil per driving:

Although high hydraulic pressure is achieved, the oil volume at each movement is very low. Hence, if the size of the hydraulic cylinder requires a high volume of oil, the time for supplying thereof will be similarly high. Furthermore, due to many movements per minute, the friction generated by the pump seal elements causes an increase in temperature of the metallic parts, said increase being transferred to the oil which will have its chemical properties compromised; in addition, the required air consumption is also high.

d) Oil suction failure in the hydraulic pressurization chamber:

The reduced piston stroke and small oil volume suction result in a very fast movement in an attempt to meet the need to deliver the largest oil volume possible per minute. The high speed can generate the phenomenon of cavitation. This is because the sucked oil does not have enough time to flow through the check valve hole.

### II. Pressure Booster

Currently when an oil volume needs to be sent to a hydraulic actuator, and when the pressure needs to be significantly increased in the end of the stroke of said actuator, a booster coupled with a conventional hydraulic unit is used, basically consisting of: An oil tank, an electric motor, a hydraulic pump for suction and oil delivery, a safety valve, a manometer, a manifold and a heat exchanger. This hydraulic unit is used to move the piston and/or hydraulic actuator to the start working point, with a given pressure generated by the pump that is driven by the electric motor. Upon arrival in the working position, in order to significantly increase the pressure a booster, which can be driven by compressed air or pressurized hydraulic oil, is used.

The driving of a booster requires an electric motor coupled with a hydraulic pump that sucks the hydraulic oil from the tank and delivers it to a hydraulic directional valve and thence to the actuator and/or hydraulic cylinder for forward or backward movement. When the actuator and/or hydraulic cylinder reaches the working position, the booster is driven by a pneumatic or hydraulic directional valve that delivers air or oil to its rear compartment exerting a great force on the hydraulic plunger, which compresses the oil stored in the pressurizing chamber, which in turn is connected with the actuator/hydraulic cylinder, thereby increasing the force thereon.

### Booster Limitations

In the conventional hydraulic unit, when the actuator and/or the hydraulic cylinder reaches the end of stroke, the electric motor continues working and pumping the oil into the system, which by not being used returns to the reservoir through the pressure regulating valve. Oil recirculation consumes electric power and generates heat in the fluid changing its properties.

The booster by itself does not perform oil pumping work, that is, it exclusively acts as a pressure booster, compressing a given oil volume confined in the pressurizing chamber, sent to this point by the hydraulic pump. Thus, its operation is totally dependent on the work of the hydraulic pump. If eventually a leak in the system occurs, the booster loses its function, since it works with a reduced oil volume that will be absent. Thus, two equipment namely the hydraulic unit and the booster are required to increase the pressure.

### III. Pressure Accumulator

In some cases instead of using a booster there is a need for a pressure accumulator, whose purpose in ensuring the maintenance of pressure in the system for a certain time, even when the electric motor of the hydraulic pump stops. An application example of pressure accumulator are the devices for fastening parts for machining.

The hydraulic pressure accumulator is placed in parallel to the pressurized oil outlet of the hydraulic unit. Hence, when the hydraulic pump delivers oil to the manifold, a portion of this oil is routed to the hydraulic pressure chamber of the accumulator. Upon arrival in this chamber, the pressure forces the plunger to rise, allowing the deposit of the largest possible oil volume in the chamber. Upon fully filling of the space, the remaining oil from the hydraulic pump continues to the manifold where it remains pressurized and ready to be used in the hydraulic cylinder. In the case of a fastening device for machining, for example, the same is moved until its arrival at the end of the stroke, where it should remain still to fulfill its function. This step involves a cylinder with nitrogen or an inert gas counterpart, having the valve open for delivering pressurized gas to the portion above the pressure accumulator plunger, exerting a force equivalent to the pressure generated by the hydraulic pump. In the event a power failure occurs ceasing the operation of the electric motor of the hydraulic unit, the fastening devices continue operating because the gas continues pushing the plunger of the pressure accumulator. If there is no electric power outages in each work cycle, that is, for every part produced, the gas stored in the accumulator is discharged into the atmosphere after closing the valve that controls its flow.

### Pressure Accumulator Limitations

The continuous operation of the electric motor pumping the oil into the system, even with the device at rest, consumes electrical power and generates heat in the fluid changing its properties. The gas used in the pressure accumulator is released in the atmosphere and is not recycled, which, besides generating cost, is not environmentally friendly.

### Prior Art

The prior art to date anticipates some patent documents referring to the subject matter under consideration, such as document No. PI 9502028-4 referring to a loom arm automatic regulator of the angular type for granite and marble, shaped by two cylinders with passer shafts connected to a hydraulic unit comprising a tank with an electric motor that activates a hydraulic pump, including a hydropneumatic accumulator with a pressure switch.

In the aforementioned document the loom arm works like a fastening device for machining components, the guarantee of its staticity being given by the hydropneumatic accumulator, excessive electric power consumption and hydraulic oil heating occurring between them due to the aforementioned limitations.

PI 0505276-9 describes an electric hydraulic power unit comprising an apparatus that includes a housing defining a chamber, an inlet hole and an outlet hole, and a movable pressure barrier in the chamber that splits it into two parts. The inlet and outlet holes are in fluid communication with the first part of the chamber. In the second part of the chamber, a driving spring biases the movable pressure barrier towards the pumping direction when it is in a compressed state, said spring being electrically compressed. Another reversal spring, placed in the first part of the chamber, impels the movable barrier to a recharge direction.

Although a pumping concomitant to pressure enhancement is performed, the use of electric power associated with the spring actuation do not reach a satisfactory degree of effectiveness and, thus, it neither solves the cost and/or expenses related to electricity, oil heating, nor proses a combined solution for pressure accumulation, should it be necessary .

### Objectives of the Invention

A first objective of the invention is to provide a unit capable of automatically playing the role of a pressure booster of a pressure accumulator, performing the same work of a conventional hydraulic pumping unit; however, replacing the electrical motor driven by compressed air at low pressure.

A second objective of the invention is to reduce the used oil volume when compared to conventional units, since the system produces hydraulic pressure and oil flow in the same unit.

A third objective of the invention is to eliminate the pulsing effect of oil delivery when compared to conventional hydropneumatic pumps, since the system is able to deliver oil constantly, continuously, and at a desired flow rate and pressure.

A fourth objective of the invention is to eliminate the time spent for filling the chamber and stopping the hydraulic cylinder when compared to hydropneumatic pumps, since it employs a dual chamber system that allows the filling of one of the chambers while the other is emptied.

A fifth objective is to automatically comply with the need for hydraulic pressure. Therefore, for instance, in the booster function, since it provides a fast filling with oil at low hydraulic pressure, upon finding resistance it blocks the low pressure pump (larger diameter) and releases only the high pressure pump supplying the working force required for that situation.

### SUMMARY OF THE INVENTION

The proposed hydraulic pressure generation unit -whose operation is based on the generation of compressed air at low pressure consists of at least one pump, preferably two, assembled in parallel and out-of-phase, the hydraulic chambers thereof having different diameters and sizes and, thus, different volumes, while the diameters of the pneumatic chambers are identical. Thus, the pump of the hydraulic chamber with the largest volume produces a lower hydraulic pressure, and is designed to move the hydraulic actuator and/or cylinder to the working position with greater speed. On the other hand, the pump with a smaller volume produces high pressure, that is, the working pressure. Thus, both the pumps work together, resulting in a greater oil flow rate. When the hydraulic actuator reaches the working position and faces resistance, the high pressure pump (smaller volume) automatically blocks the lower oil outlet of the low pressure pump (larger volume); at this time starting to act as a booster providing the advantage of continuing its operation even in case of leakage in the system.

### Advantages of the Invention

In brief, the present patent application herein provides the following advantages that should be highlighted:

Versatility—it automatically fits the required hydraulic pressures;

Electricity economy of about 90%;

It uses a very low oil volume;

Noise elimination;

Eliminates the pulsating effect

### DESCRIPTION OF THE DRAWINGS

In order to provide a full view of the inventive activity, applicability and operation of the “HYDRAULIC PRESSURE GENERATION UNIT WITH PNEUMATIC ACTUATION”, and further disclose this specification an explanation is provided herein with reference to the attached drawings, which are depicted in an illustrative and not limiting way:

FIG. 1: Schematic view of the hydraulic pressure generation unit with pneumatic actuation, with two pumps;

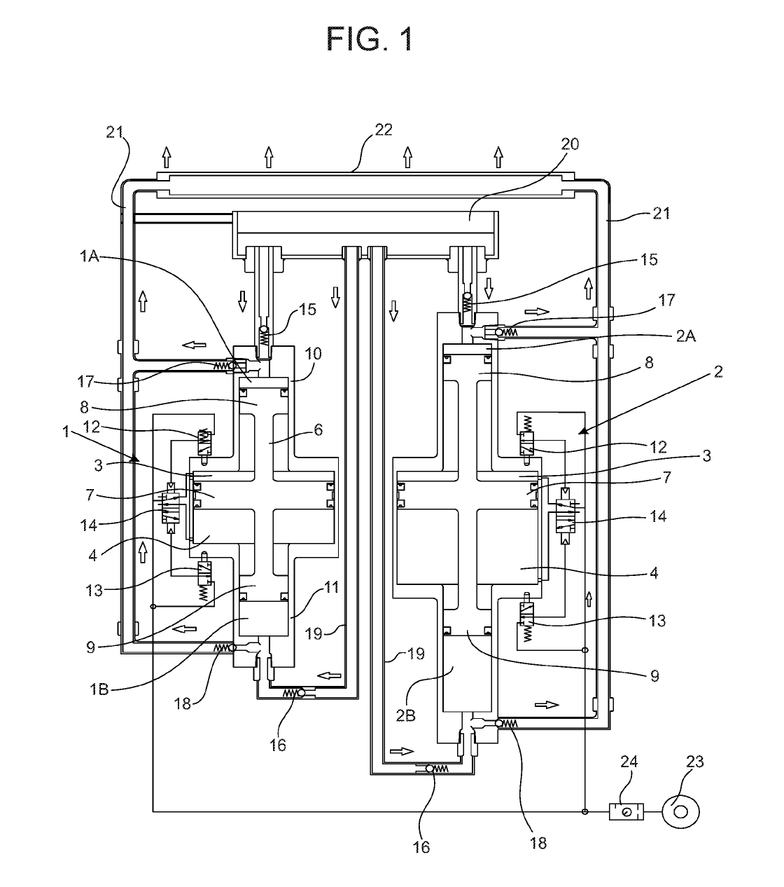

FIG. 2: Schematic view of the pump of the hydraulic pressure generation unit with pneumatic actuation;

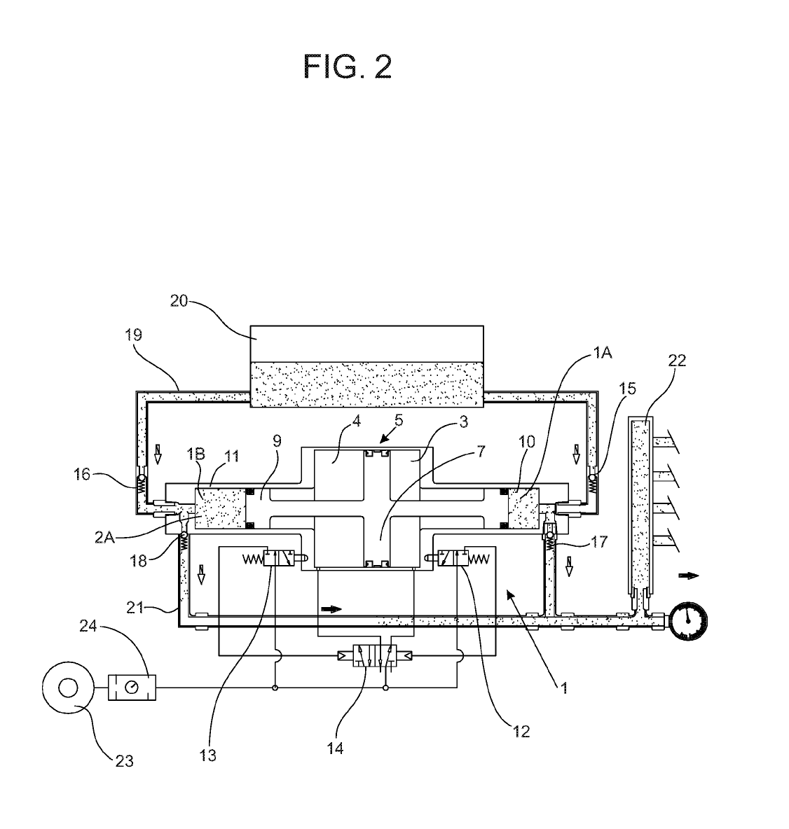

FIG. 3: Schematic enlarged view of the pneumatic system of the pump of the hydraulic pressure generation unit with pneumatic actuation;

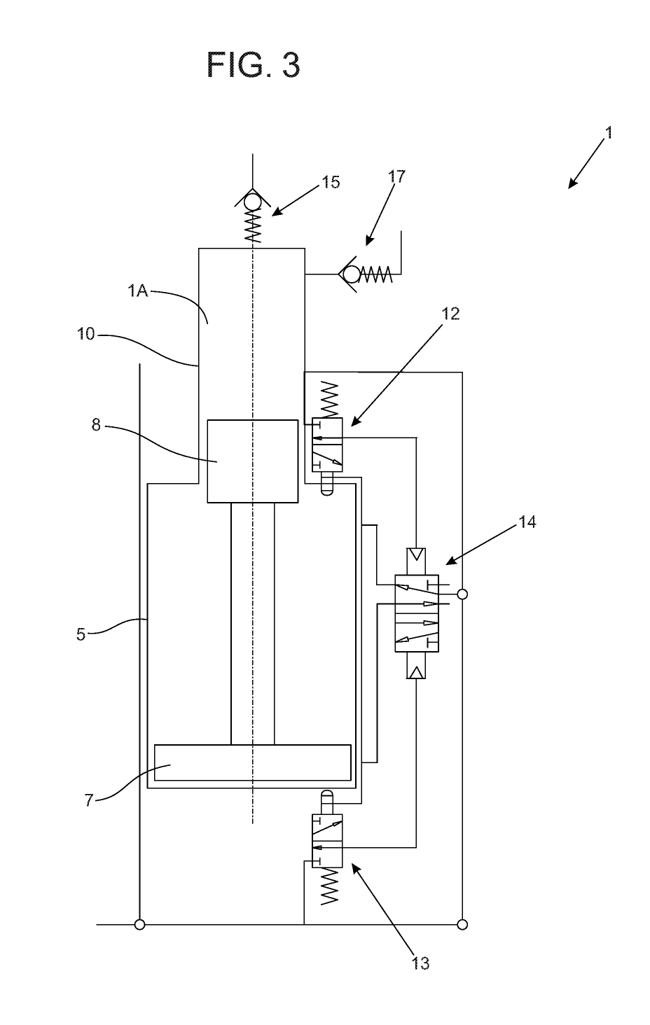

FIG. 4: Schematic view of the hydraulic pressure generation unit with pneumatic actuation, with two pumps, applied to a set of existing cylinders.

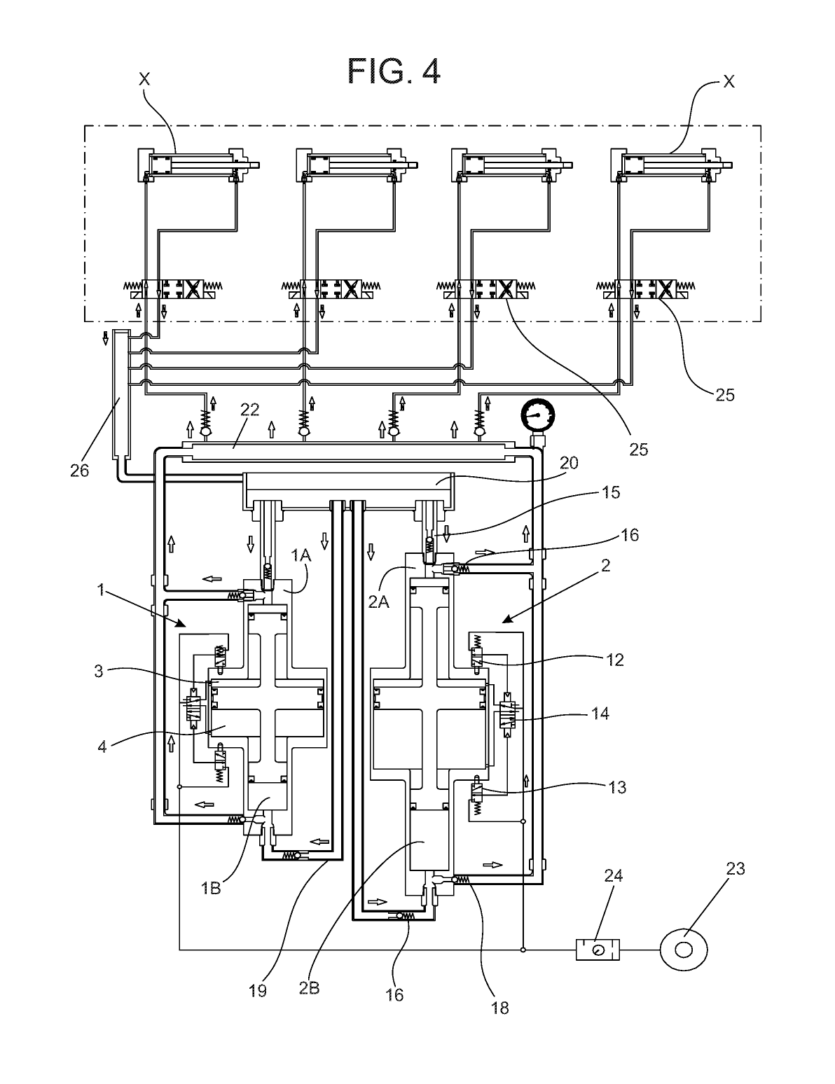

### DETAILED DESCRIPTION OF THE INVENTION

The “HYDRAULIC PRESSURE GENERATION UNIT WITH PNEUMATIC ACTUATION” herein consists of at least one pump, in a preferred embodiment of the invention by two pumps (1 and 2) assembled in parallel, one of them (1) having the volume and diameter of the hydraulic chamber (1 A and 1B) smaller than the volume of the hydraulic (2 A and 2B) of the complementary pump (2); however both having the same diameters as the upper and lower pneumatic plungers (3 and 4), respectively. The central body of the pumps (1 and 2) is a pneumatic cylinder (5) with a passer shaft (6) shaping a medial plunger (7) and two symmetrical and opposite hydraulic plungers (8 and 9) at the ends, which slide on a hydraulic sleeve (10 and 11). Pumps (1 and 2) having an automatic reversing system better depicted by upper (12) and lower (13) pneumatic reversing valves in a position such that it can be touched by the pneumatic plunger (7) that, in combination with the action of a pneumatic directional valve (14), directs the pump movement to the right direction. Therefore, suction check valves (15 and 16) and outlet check valves (17, 18) need to be strategically placed in the hydraulic chambers (1 A and 1 B, 2 A and 2B), both in the low pressure suction pipes (19) from the oil reservoir (20) and in the high pressure pipes (21) from the upper chambers (1A and 2A) and bottom chambers (1B and 2B), which follow to the manifold (22) and therefrom to the application in a block and/or hydraulic cylinders (X).

The automatic movement of the pumps (1 and 2) takes place pneumatically. In this embodiment of the invention, the three-ways and two-positions upper (12) and lower (13) pneumatic reversing valves have three holes, one of which being connected with the air supply line (23). The additional holes are connected together, one of them being connected with the five-ways and two-position pneumatic directional valve (14) that drives the pneumatic cylinder (5) of the pump, while the other hole is intended for air disposal in the atmosphere. When the pneumatic reversing valve (12) is at rest, the pressure hole is blocked. Hence, upon driving the pneumatic reversing valve (12) by means of a pin at its end, the pressure hole moves into the other position and connects with the other hole to change the position of the pneumatic directional valve (14). The pin of the pneumatic reversing valve (12) is activated by the mechanical contact of the pneumatic plunger (7), which running to its end of the stroke pushes it, changing the position of said valve (12). Upon change of position, while the air of the upper pneumatic chamber (3) is exhausted in the atmosphere, the pneumatic directional valve (14) causes the compressed air that was entering the lower pneumatic chamber (4) to reverse the direction of its flow, sending the pressurized air to the upper pneumatic chamber (3) and exhausting the air of the lower pneumatic chamber (4) in the atmosphere. This reversal takes place automatically once the pneumatic plunger (7) reaches the end of the stroke and touches the reversing valves (12 and 13). Upon these automatic position changes of the reversing pneumatic valves (12 and 13), the pump enters in continuous work regime, sucking the oil from the reservoir (20) with the same movement carried out to pressurize and push the oil to the system in the opposite chamber.

Under an operational perspective, the pumps (1 and 2) begins moving automatically releasing air to the system, which takes place by opening the pressure regulating valve (24). Initially the circuit is empty, that is, without oil, so that the pumps (1 and 2) start the work of sucking the oil from the reservoir (20) and delivering it to the manifold (22). In this moment there is no pressure in the circuit since the pipes are empty. Each pump (1 and 2) is pre-sized to produce a given volume of oil, which is measured in liters per minute, as well as to generate a given hydraulic pressure. Upon circuit being filled with oil and achieving the designed hydraulic pressure, pumps (1 and 2) stop working automatically. The operational stop occurs because upon achieving the maximum hydraulic pressure, a hydraulic force opposes to the applied force that was generated by the pneumatic plunger (7). Therefore, the circuit remains pressurized and the pumps (1 and 2) start actuating as a hydraulic pressure accumulator that are always assembled and ready to replace any oil volume that might leak from the circuit. In this instance, there is no air consumption and, thus, no electricity consumption for producing compressed air. Manifold (22) is connected to the hydraulic directional valves (25) that are part of the equipment comprising the block and/or hydraulic cylinders (X) that will use the invented unit. To move the hydraulic actuator of the equipment, the hydraulic directional valve (25) must be activated in order to send the oil that is accumulated and pressurized in the manifold (22) to one of the chambers of the hydraulic cinder (X) and start moving. When the oil that is pressurized in the manifold (22) start being released by the directional valve (25), a pressure drop occurs in the circuit. In this moment, the force generated by the pneumatic plunger (7) that is applied to the hydraulic plunger (8) is greater than the hydraulic resistance force of the manifold (22) and, thus, the pump automatically starts moving to fill the circuit and generate hydraulic pressure. When the directional valve (25) delivers oil to the rear chamber of the hydraulic cylinder (X), the oil stored in the front chamber of the hydraulic cylinder (X) is pushed to the return block (26) and conveyed to the reservoir (20) by gravity. Upon reaching the end of the stroke of the hydraulic cylinder (X), the hydraulic pressure in the circuit is increased and upon reaching the maximum hydraulic pressure, the pumps (1 and 2) will stop working again and will maintain the circuit pressurized until another actuator starts the forward or backward movement and the whole process restarts.

Pumps (1 and 2) have different functions in the design, one of them acting as filling pump and the other acting as filling and pressurizing pump. In this embodiment of the invention, the volume of the hydraulic chamber (2 A and 2B) of the first filling pump (2) is larger than the one of the chamber (1 A and 1 B) of the second pump (1). The pneumatic plunger (7) exhibits the same diameter in both the pumps (1 and 2). Thus, the pressure of the first pump (2) is lower than that of the second pump (1). Upon each pump movement (1 and 2), the oil volume of the first pump (2) is larger than that of the second pump (1) and, thus, the sum of the two volumes shows the desired volume in liters per minute, which will determine the speed of the actuators. When the cylinders (X) face resistance, the pumps (1 and 2) that until that moment were performing the same filling function, change function, that is, the low pressure pump (2) is automatically blocked by the check valve under the higher pressure generated by the high pressure pump (1).

In this invention, pumps (1 and 2) work out-of-phase so that when one reaches the end of the stroke, the other pump still continues delivering oil to the circuit, not allowing pulsating movement.

Another distinctiveness is that the pumps (1 and 2) have two pressurizing chambers (1 A and 1 B, 2 A and 2B), thus, while the plungers (8 and 9) leads to the circuit, exerting hydraulic pressure, chambers interconnected by the same plunger that are placed opposite at the other end, are filled by sucking oil from the reservoir. Therefore, when the cylinder (X) reaches the end of the stroke, there is no need to wait for the pumps (1 and 2) to suck oil from the reservoir (21) and then start pushing it again. Hence, when the pumps (1 and 2) start the motion work, upon the compressed air being released by the valve (25), pneumatic plungers (7) start together in order to displace the hydraulic plungers (8 and 9) by sucking the oil from the reservoir (20) to fill the hydraulic chambers (1 A and 2 A). Pump (1) having the smaller chamber volume is first filled and, when it reaches the end of the stroke, pumps (2), due to its larger volume, still continues the filling motion of the upper hydraulic chamber (2A). Upon reaching the end of the stroke, the pump (1) drives an automatic reversal system and starts its return movement by compressing the oil that is stored in the hydraulic chamber (1 A), while pump (2) continues its filling motion of the hydraulic chamber (2 A). When the pump (2) reaches the end of the stroke, the automatic reversal is driven and said pump (2) start it return movement by compressing the oil stored in the hydraulic chamber (2 A), while the pump (1) as well continues its motion by compressing the oil and leading it under pressure to the point of use. At this stage those two pumps (1 and 2) deliver oil to the point of use. During this displacement involving oil compression and deliver to the point of use, lower hydraulic chambers (1 B and 2 B) are filled by suction being carried out by the hydraulic plungers (9). Upon reaching the end of the stroke, pump (1), the lower hydraulic chamber (1B) will be fully filled, and upon starting the automatic reversal, the oil flow delivered to the point of use in not interrupted for two reasons: First, because the pump (2) continues delivering oil, and second because pump (1) does not require time to supply hydraulic chamber, as it has already been filled at the same time that compression was exerted. The same will occur to the pump (2) upon reaching the end of its stroke and thus it will occur consecutively, and the pumps (1 and 2) will never interrupt the oil flow to the point of use because they intentionally work out-of-phase.

Depending on the application, generation units may include only one pump or two or more pumps, varying according to the design and final use.

In most cases hydraulic pressure generation unit will consist of two pumps.

1. A hydraulic pressure generation unit with pneumatic actuation driven by low pressure air and that automatically acts as pump, booster and accumulator of pressure, comprising two pumps (1 and 2) operated in parallel and out-of-phase and comprising a pneumatic cylinder (5) with a medial plunger (7) limiting pneumatic chambers (3 and 4), in relation to two external hydraulic plungers (8 and 9) actuating in upper hydraulic chambers (1A and 2A) and lower hydraulic chambers (1B and 2B) having different volumes; wherein:
while one chamber (1A or 2A and 1B or 2B) is filled, the other chamber (1A or 2A and 1B or 2B) is emptied continuously;
pumps (1 and 2) have an automatic reversal system; and
one or more sucking check valves (15 and 16) and outlet check valves (17 and 18) placed in the hydraulic chambers (1A and 1B, 2A and 2B) provide the oil flow respectively to one or more low pressure sucking pipes (19) from an oil reservoir (20), and to one or more high pressure pipes (21) from the upper chambers (1A and 2A) and lower chambers (1 B and 2B), which follow to a manifold (22) and thence to the application in a block and/or hydraulic cylinders (X).

2. The hydraulic pressure generation unit with pneumatic actuation according to claim 1 wherein, when the unit is working out-of-phase and a pump (1 or 2) reaches the end of the stroke, the other pump (1 or 2) continues pumping.

3. The hydraulic pressure generation unit with pneumatic actuation according to claim 1 wherein the pumps (1 and 2) each have two pressurizing chambers (1A and 2A, 1B and 2B).

4. The hydraulic pressure generation unit with pneumatic actuation according to claim 3 wherein, when the pressurizing chamber (2A or 2B) is filled by sucking the oil from the reservoir (20) or vice versa, the plunger (8) of the pressurizing chamber (1A or 1B) leads said oil to the circuit.

5. The hydraulic pressure generation unit with pneumatic actuation according to claim 1 wherein one of the pumps actuates by filling and the other by filling and pressurizing the circuit.

6. The hydraulic pressure generation unit with pneumatic actuation according to claim 1 wherein the pumps (1 and 2) have upper (12) and lower (13) pneumatic reversing valves that when touched by the pneumatic plunger (7) in combination with the action of a pneumatic directional valve (14), direct the right path of the pumps movement and the pressurization and suction flows.

7. The hydraulic pressure generation unit with pneumatic actuation according to claim 1 wherein changing position of the pneumatic directional valve (14) causes the lower (4) and upper (3) pneumatic chambers to shift.

8. The hydraulic pressure generation unit with pneumatic actuation according to claim 7 wherein, upon the automatic position changes of the pneumatic reversing valves (12 and 13), the pump enters in continuous work regime, sucking oil from the reservoir (20) with the same movement done to pressurize and lead the oil to the system.

9. The hydraulic pressure generation unit with pneumatic actuation according to claim 1 wherein, when the cylinders (X) face resistance, the unit automatically enters the booster mode.

10. The hydraulic pressure generation unit with pneumatic actuation according to claim 9 wherein, the pumps (1 and 2) are actuating in filling change function; and the low pressure pump (2) is automatically blocked by a check valve, by the higher pressure generated by the high pressure pump (1).

11. The hydraulic pressure generation unit with pneumatic actuation according to claim 1 wherein, upon reaching the design hydraulic pressure, the pumps (1 and 2) automatically stop working, when the limit force achieves that applied by the plunger (7).

12. The hydraulic pressure generation unit with pneumatic actuation according to claim 11 wherein the unit, upon reaching the design hydraulic pressure, maintains the pressure and enters in pressure accumulator mode.

13. The hydraulic pressure generation unit with pneumatic actuation according to claim 1 wherein the unit can operate with only one pump.
